(19) United States
(12) Patent Application Publication
(10) Pub. No.: US 2009/0303396 A1
(43) Pub. Date: Dec. 10, 2009

(54) PICTURE DISPLAY DEVICE

(75) Inventors: Takafumi HAYASHI, Osaka-shi (JP); Hiroshi YAMAGA, Nara-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/479,352

(22) Filed: Jun. 5, 2009

(30) Foreign Application Priority Data
Jun. 6, 2008 (JP) 2008-149397

(51) Int. Cl. H04N 5/66

(52) U.S. Cl. 348/739; 348/E05.133

(57) ABSTRACT

A picture display device having a plurality of functions individually settable as a plurality of setting items. The picture display device includes a display which shows a picture. A display controller shows on the display an index corresponding to a setting pattern of setting contents of the plurality of setting items. A function control unit simultaneously sets the plurality of functions in accordance with the setting contents of the plurality of setting items in the setting pattern when receiving a signal indicating the index.

### CROSS-REFERENCE TO RELATED APPLICATIONS

This application is based upon and claims the benefit of priority from the prior Japanese Patent Application No. 2008-149397, filed on Jun. 6, 2008, the entire contents of which are incorporated herein by reference.

### BACKGROUND OF THE INVENTION

The present invention relates to picture display devices, such as televisions, used in guest rooms of lodging facilities and the like.

A typical picture display device such as a television, which includes a display for showing pictures, has functions that can be set by a user (i.e., person using the picture display device). The user operates an operation unit arranged on the picture display device or a remote controller and sets each of the functions as a setting item.

The setting of the setting items for the desired functions is burdensome. For example, when pressing buttons on a remote controller to set the functions, buttons must be pressed for a number of times that is at least as great as the number of setting items. Thus, function setting becomes more complicated as the number of setting items increases. Especially, when picture display devices such as televisions are used in guest rooms of lodging facilities and the like, the functions must be set for many picture display devices. Therefore, if the setting of the functions is burdensome, human error such as erroneous setting of a function may occur.

To simplify function setting, a plurality of setting items may be simultaneously set. Such simultaneous function setting of a plurality of setting items is known in the art. The simultaneous setting of the plurality of functions is based on setting contents of a table that corresponds to a mode selected by a person who sets the functions. The setting contents registered in the table may be changed.

However, in this arrangement, when setting the functions for a plurality of picture display devices, it is difficult to set a plurality of setting items in a given pattern (i.e., a combination of any of the setting contents) for the functions of each device. In other words, there is a limit to the setting patterns enabling simultaneous function setting in a predetermined mode. Even if the setting contents are changeable in the table corresponding to the selected mode, the changed table setting contents would be reflected in only one of the picture display devices. Accordingly, it is difficult to make the same function settings in a given pattern for a plurality of picture display devices.

### SUMMARY OF THE INVENTION

The present invention provides a picture display device that allows for functions of a plurality of picture display devices to be easily set in a given setting pattern.

One aspect of the present invention is a picture display device having a plurality of functions individually settable as a plurality of setting items. The picture display device includes a display which shows a picture. A display controller shows on the display an index corresponding to a setting pattern of setting contents of the plurality of setting items. A function control unit simultaneously sets the plurality of functions in accordance with the setting contents of the plurality of setting items in the setting pattern in response to input of a signal indicating the index.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing the structure of a television serving as a picture display device according to a preferred embodiment of the present invention;

FIG. 2 is a plan view showing a remote controller;

FIG. 3 is a flowchart showing the operation of the television of FIG. 3;

FIG. 4 is a flowchart showing the procedures for setting the functions of a plurality of televisions;

FIG. 5 is a flowchart showing the procedures for setting the functions of a single television;

FIG. 6 is a front view of a display showing a commercial setting menu screen used to select a setting item;

FIG. 7 is a front view of the display showing a commercial setting menu screen used to select a setting content;

FIG. 8 is a front view of the display showing a commercial setting menu screen used to select a setting content;

FIG. 9 is a front view of the display showing a commercial setting menu screen used to select a detailed setting item;

FIG. 10 is a front view of the display showing a setting value corresponding to a setting pattern;

FIG. 11 is a diagram showing the relationship between a setting pattern and a setting value;

FIG. 12 is a flowchart showing the procedures for setting functions in televisions following the one that is first set; and

FIG. 13 is a front view of the display showing a commercial setting menu;

FIG. 14 is a front view of the display showing a commercial setting menu used to input a setting value in a state before the input of a setting value;

FIG. 15 is a front view of the display showing a commercial setting menu used to input a setting value in a state in which the input of a setting value is completed; and

FIG. 16 is a front view of the display showing a commercial setting menu reflecting the setting contents of a setting pattern corresponding to the setting value.

### DETAILED DESCRIPTION OF THE PREFERRED EMBODIMENTS

In the drawings, like numerals are used for like elements throughout.

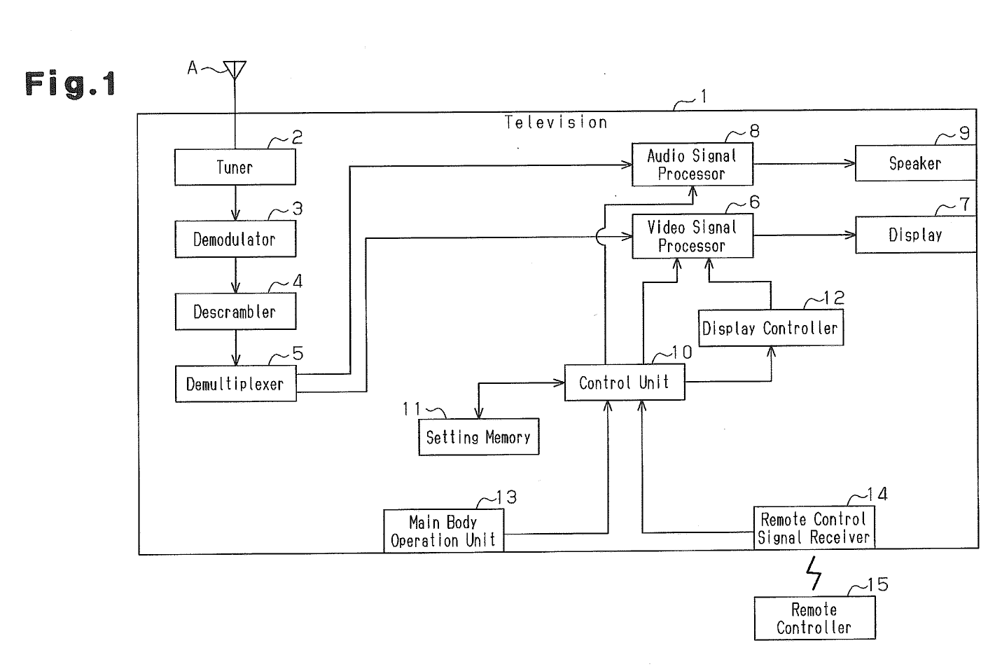

A preferred embodiment of the present invention will now be discussed with reference to the drawings. FIG. 1 is a schematic block diagram showing the structure of a television serving as a picture display device according to a preferred embodiment of the present invention. As shown in FIG. 1, the television 1, which serves as a picture display device, receives broadcast signals. The television 1 shows pictures on a display 7, which serves as a display unit, based on picture information contained in the broadcast signals. Further, the television 1 reproduces sound from a speaker 9 based on audio information contained in the broadcast signals.

The television 1 is a commercial picture display device, which is used, for example, in the guest room of a lodging facility and the like, and has a plurality of functions. For instance, the television 1 has a function for prohibiting the operation of a main body operation unit 13, a function for prohibiting the switching of inputs, a function for prohibiting the display of a setting menu, a function for prohibiting the operation of a remote controller 15, and a function for setting the maximum volume. The settings of these functions may be changed.

The television 1 includes a tuner 2 connected to an antenna A, which receives digital broadcast signals (hereinafter simply referred to as “broadcast signals”). A demodulator 3 demodulates signals output from the tuner 2 and performs error code correction. A descrambler 4 descrambles scrambled signals, which are demodulated by the demodulator 3.

The television 1 also includes a demultiplexer 5, which separates a descrambled signal into video data, audio data, and the like, a video signal processor 6, which performs signal processing on video signals, the display 7, an audio signal processor 8, which performs signal processing on audio signals, and the speaker 9.

The television 1 also includes a control unit 10 (function control unit), which controls each part of the television 1 (e.g., the tuner 2, video signal processor 6, and audio signal processor 8), a setting memory 11, a display controller 12, a main body operation unit 13, and a remote control signal receiver 14.

The control unit 10 is a central processing unit (CPU) or a microcomputer that executes programs stored in a memory (not shown) and outputs control signals to the video signal processor 6, the audio signal processor 8, and the display controller 12 to control each part of the television 1.

Based on a signal input to the control unit 10, the control unit 10 writes and stores in the setting memory 11 setting contents for setting items required when setting a function of the television 1. In other words, the control unit 10 writes the setting contents for each setting item in the setting memory 11 so that the functions of the television 1 are effective in the preferred manner in accordance in the setting contents stored in setting memory 11. More specifically, when receiving a signal for selecting a setting content, the control unit 10 writes the selected setting content to the setting memory 11 to set the setting item of each function. When a signal representing a setting value is input to the control unit 10, the control unit 10 writes the setting contents of the setting items in accordance with a setting pattern (i.e., combination of setting contents) corresponding to the setting value. This simultaneously sets a plurality of setting items for a plurality of functions.

In addition to writing and storing setting contents in the setting memory 11, the control unit 10 performs operations that are in accordance with signals input to the control unit 10 by the main body operation unit 13 or the remote control signal receiver 14.

The setting memory 11 is a writable and erasable non-volatile memory such as an EEPROM. Setting contents for setting items required to set the functions of the television 1 are written to and stored in the setting memory 11. In the preferred embodiment, the five functions described above are defined as five setting items, which are “prohibit operation of main body operation unit”, “prohibit switching of inputs”, “prohibit display of setting menu”, “prohibit operation of remote controller”, and “set maximum volume”. For each of these setting items, the setting content of either “YES” or “NO” (i.e., information indicating whether or not the function is effective) is selected and stored in the setting memory 11. Further, a “maximum volume value” (i.e., information indicating maximum volume), which is a supplemental setting content for supplementing function setting, is provided for the setting item of “set maximum volume”. The “maximum volume value” is stored in the setting memory 11.

Each function of the television 1 becomes effective based on the setting content stored in the setting memory 11. More specifically, when the setting content for “prohibit operation of main body operation unit” is “YES” thereby indicating that this function should be effective, the control unit 10 invalidates signals received from the main body operation unit 13. Thus, the function of the television 1 for prohibiting operation of the main body operation unit 13 is effective. When the setting content for “prohibit switching of inputs” is “YES”, the control unit 10 invalidates signals for switching video signals received from the video signal processor 6 and audio signals received from the audio signal processor 8. Thus, the function of the television 1 for prohibiting switching of inputs is effective. When the setting content for “prohibit display of setting menu” is “YES”, the control unit 10 invalidates signals for displaying the setting menu. Thus, the function of the television 1 for prohibiting the display of the setting menu is effective. When the setting content for “prohibit operation of remote controller” is “YES”, the control unit 10 invalidates signals received from the remote controller 15. Thus, the function of the television 1 for prohibiting operation of the remote controller 15 is effective. When the setting content for “set maximum volume” is “YES”, the control unit 10 sends the “maximum volume value” stored in the setting memory 11 as a control signal to the audio signal processor 8. Thus, the function of setting the maximum volume for the television 1 is effective.

The display controller 12, which functions as an on screen display (OSD) controller, generates OSD signals to show an OSD image such as a commercial setting menu on the display 7. The display controller 12 sends the generated OSD signal to the video signal processor 6 to show the image of a setting menu (i.e., OSD image), which differs from pictures shown in accordance with the video information included in broadcast signals, on the display 7. For example, the display controller 12 shows setting items, setting contents, and setting values on the display 7. A setting value is used as an index corresponding to a setting pattern of the setting items.

The main body operation unit 13 includes a button (not shown), which is for switching the power of the television 1 between ON and OFF, and a button (not shown), which is for switching channels. A signal corresponding to the operated button is sent from the main body operation unit 13 to the control unit 10. For instance, when the button for switching the power between ON and OFF for the television 1 is pushed, a signal indicating the switching of the power is sent to the control unit 10. When the button for switching channels is pushed, a signal indicating the switching of channels is sent to the control unit 10.

The remote control signal receiver 14 receives a signal (i.e., remote control signal) transmitted from a remote controller 15, which remotely operates the television 1. The remote control signal receiver 14 is an infrared receiving element for receiving the remote control signal transmitted by infrared rays. The signal received by the remote control signal receiver 14 is input to the control unit 10.

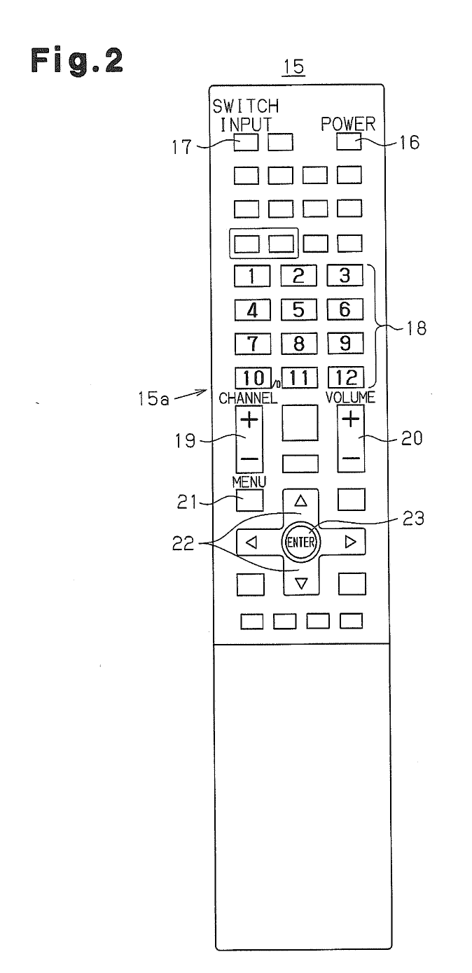

As shown in FIG. 2, the remote controller 15 includes an operation unit 15a operated by the user. The operation unit 15a includes buttons such as a power key 16, an input switch key 17, numerical keys 18, a channel key 19, a volume key 20, a menu key 21, a cursor movement key 22, and an enter key 23. When a button is operated, the remote controller 15 transmits a signal corresponding to the operated button to the remote control signal receiver 14. In other words, a signal indicating that the power has been switched ON or OFF is transmitted when the power key 16 is pushed. A signal indicating the switching of video signals input to the video signal processor 6 or audio signals input to the audio signal processor 8 is transmitted when the input switch key 17 is pushed. Furthermore, a signal indicating input numbers is transmitted when the numerical keys 18 are pushed, and a signal indicating the switching of channels is transmitted when the channel key 19 is pushed. A signal indicating adjustment of the volume of sound reproduced from the speaker 9 (audio output volume) is transmitted when the volume key 20 is pushed, and a signal for displaying a setting menu to start a normal setting is transmitted when the menu key 21 is pushed. A signal for selecting a setting item or setting content is transmitted when the cursor movement key 22 is pushed, and a signal determining the selected setting item or setting content is transmitted when the enter key 23 is pushed.

Accordingly, the control unit 10 operates in accordance with signals input from the remote control signal receiver 14 or the like. For example, when receiving a signal for displaying the setting menu when the menu key is operated, the control unit 10 sends a control signal to the display controller 12. Then, the display controller 12 sends an OSD signal to the video signal processor 6 to display a setting menu.

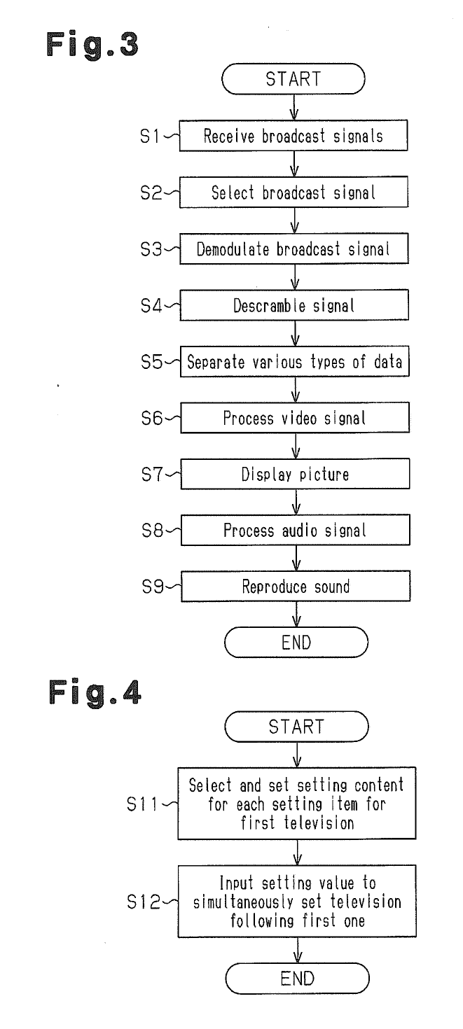

The operation of the television 1 to produce pictures on the display 7 and sound with the speaker 9 based on the video data and audio data contained in broadcast signals when the power of the television 1 is turned ON will now be discussed with reference to FIG. 3.

First, the antenna A receives a broadcast signal transmitted from a broadcast station. Then, the antenna A sends the received broadcast signal to the tuner 2 (step S1). The broadcast signal contains video data and audio data. For digital broadcasts, the video data and audio data are multiplexed in broadcast signals in compliance with MPEG-2 Systems.

From the broadcast signals received from the antenna A, the tuner 2 selects a broadcast signal that corresponds to the channel specified by the user and sends the selected broadcast signal to the demodulator 3 (step S2). In other words, the tuner 2 retrieves a broadcast signal of a specific frequency from the broadcast signals and sends the retrieved broadcast signal to the demodulator 3.

The demodulator 3 then A/D converts and demodulates the broadcast signal selected by the tuner 2 and performs error code correction for checking whether or not an error occurred in the transmission path. Then, the demodulator 3 outputs the demodulated, error code corrected signal to the descrambler 4 (step S3).

When the signal is scrambled, the descrambler 4 uses a descramble key stored in an IC card (not shown) to descramble the signal. The descrambler 4 then sends the non-scrambled signal in Transport Stream (TS) format to the demultiplexer 5 (step S4).

The demultiplexer 5 separates the video data, the audio data, and the like from the TS format signal. Then, the demultiplexer 5 sends the separated data to the video signal processor 6 and the audio signal processor 8 (step S5). More specifically, the separated video data is sent to the video signal processor 6 as a video signal, and the separated audio data is sent to the audio signal processor 8 as an audio signal.

The video signal processor 6 performs various types of signal processing on the video signal, which includes the video data (step S6). For instance, the video signal processor 6 decodes video data that is compression coded in the MPEG-2 Video format. When receiving the OSD signal from the display controller 12, the video signal processor 6 combines the OSD signal with the video signal to show the OSD image on the display 7.

Then, the video signal that has undergone various types of signal processing in the video signal processor 6 is sent to the display 7. Based on the video signal, the display 7 displays a picture (step S7).

The audio signal processor 8 performs various types of signal processing on the audio signal, which includes the audio data (step S8). For instance, the audio signal processor 8 decodes audio data that is compression coded in the MPEG-2 AAC format. When receiving the “maximum volume value” stored in the setting memory 11 as a control signal, the audio signal processor 8 performs signal processing for adjusting the volume of sound reproduced from the speaker 9 in accordance with the “maximum volume value”.

The audio signal that has undergone signal processing in the audio signal processor 8 is sent to the speaker 9. Based on the audio signal, the speaker 9 reproduces sound (step S9). Steps S6 and S7 are operations that may be performed in parallel with steps S8 and S9.

In this embodiment, as described above, the features of the television 1 is in the display controller 12, which displays a setting value corresponding to a setting pattern for a plurality of setting items, and the control unit 10, which simultaneously sets functions by setting a plurality of setting items based on the signal indicating the setting value.

For example, if the television 1 is one of a plurality of televisions 1 used for commercial purposes and installed in guest rooms of a lodging facility, the televisions 1 are set to have the same function settings. The functions of each television 1 are set in accordance with the procedures shown in FIG. 4. For the television 1 that is first set, setting contents are selected for each setting item (step S11). For a television 1 following the first one, a setting value corresponding to the setting pattern of the first television 1 is input so as to simultaneously set the functions (step S12).

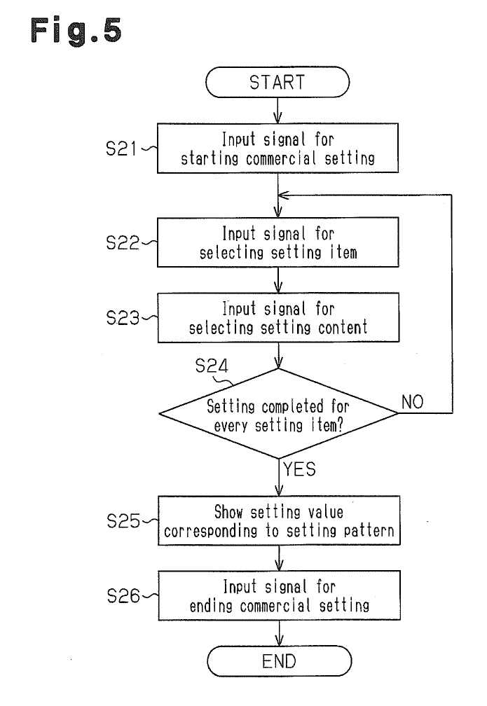

The procedures for selecting and setting the setting content for each setting item of the functions of the first television 1 will now be discussed with reference to FIG. 5.

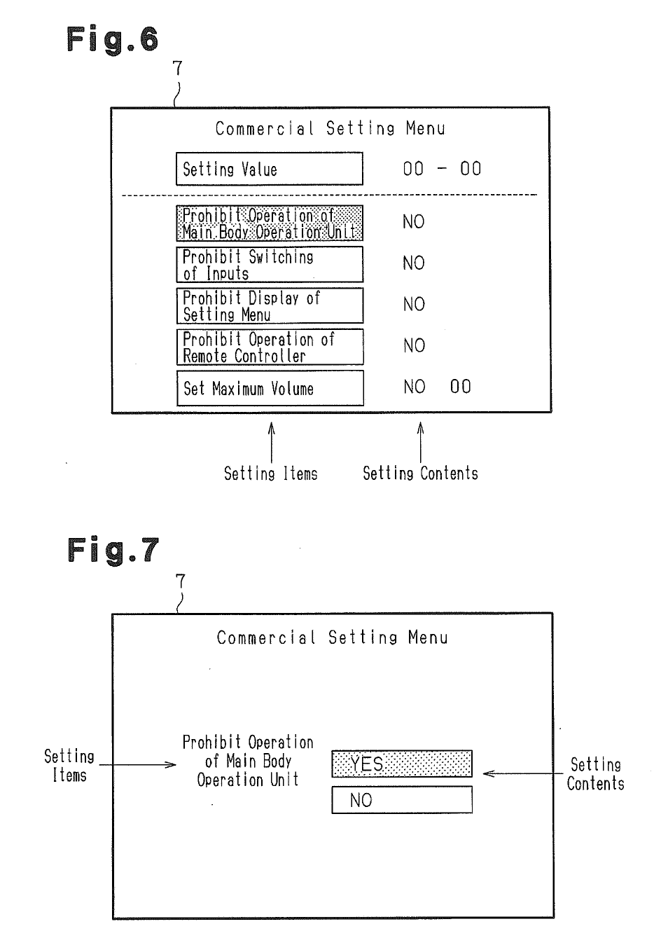

First, an employee or the like of a lodging facility who manages the television 1 operates the main body operation unit 13 or the operation unit 15a of the remote controller 15. This sends a signal for starting commercial setting to the control unit 10 (step S21). The operation for sending the signal starting the commercial setting to the control unit 10 is performed by, for example, simultaneously pushing a plurality of buttons. It is preferable that such operation be one that is normally not performed by a general user. When receiving the signal for starting the commercial setting, the control unit 10 sends a control signal to the display controller 12, which in turn sends an OSD signal to the video signal processor 6. As a result, a commercial setting menu, which is an OSD image as shown in FIG. 6, appears on the display 7 so that a setting item may be selected.

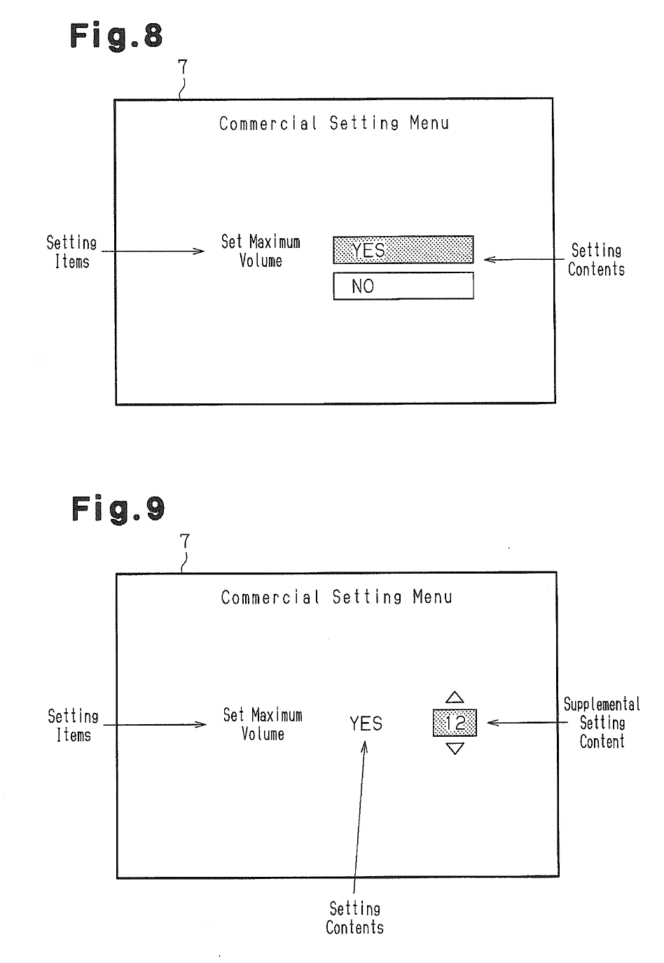

Then, the cursor movement key 22 and the enter key 23 of the remote controller 15 are operated to send a signal for selecting a setting item to the control unit 10 (step S22). That is, the employee or the like of the lodging facility operates the cursor movement key 22 and the enter key 23 of the remote controller 15 while referring to the commercial setting menu (FIG. 6) shown on the display 7 to select one of the setting items of “prohibit operation of main body operation unit”, “prohibit switching of inputs”, “prohibit display of setting menu”, “prohibit operation of remote controller”, and “set maximum volume”. When receiving a signal indicating the selection of a setting item, the control unit 10 sends a control signal to the display controller 12. In response to the control signal, the display controller 12 sends an OSD signal to the video signal processor 6. As a result, a commercial setting menu, which is an OSD image as shown in FIGS. 7 and 8, appears on the display 7 so that a setting content may be selected.

The cursor movement key 22 and the enter key 23 of the remote controller 15 are operated to select a setting content, and a signal indicating the selected setting content is sent to the control unit 10 (step S23). That is, the employee or the like of the lodging facility operates the cursor movement key 22 and the enter key 23 of the remote controller 15 while referring to the commercial setting menu shown on the display 7 to select either “YES” or “NO” as the setting content for “set maximum volume”, the control unit 10 sends a control signal to the display controller 12 to perform a supplemental setting. In response to the control signal, the display controller 12 sends an OSD signal to the video signal processor 6. As a result, a commercial setting menu, which is an OSD image as shown in FIG. 9, appears on the display 7 so that a supplemental setting content may be selected. The employee or the like of the lodging facility operates the cursor movement key 22 and the enter key 23 of the remote controller 15 while referring to the commercial setting menu to select a “maximum volume value”, which is a supplemental setting content for setting the function related to the setting item of “set maximum volume”. For example, the “maximum volume value” is indicated by a numerical value, and a signal indicating the selected numerical value is input to the control unit 10. The control unit 10 writes and stores the setting content selected in step S23 in the setting memory 11. Such a supplemental setting content is stored in association with the setting pattern.

In this manner, when setting the functions of the first television 1, the setting content for each of a plurality of setting items is selected to set each function. This enables the employee or the like of the lodging facility to set the functions in any setting pattern of the plurality of setting items.

Next, the control unit 10 determines whether settings are completed for each of the setting items (step S24). The settings are completed when “YES” or “NO” is selected as the setting content for every one of the setting items of “prohibit operation of main body operation unit”, “prohibit switching of inputs”, “prohibit display of setting menu”, “prohibit operation of remote controller”, and “set maximum volume”. The setting are incomplete when “YES” or “NO” is not selected as the setting content for every one of the setting items of “prohibit operation of main body operation unit”, “prohibit switching of inputs”, “prohibit display of setting menu”, “prohibit operation of remote controller”, and “set maximum volume”. When the settings are incomplete, steps S22 to S24 are repeated.

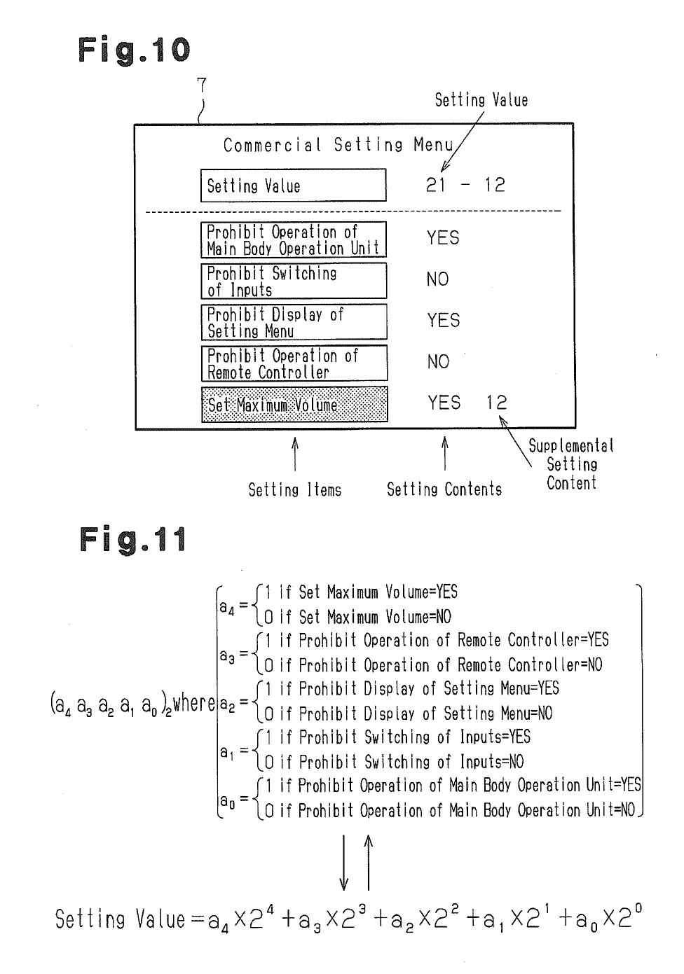

When determined in step S24 that the settings are completed, the display controller 12 sends an OSD signal to the video signal processor 6. As a result, a setting value, which serves as an index corresponding to a setting pattern of the setting items, appears on the display 7 as shown in FIG. 10 (step S25). That is, a setting value corresponding to a setting pattern of the setting items of “prohibit operation of main body operation unit”, “prohibit switching of inputs”, “prohibit display of setting menu”, “prohibit operation of remote controller”, and “set maximum volume” is shown on the display 7. The setting value corresponding to a setting pattern may be obtained, for example, by converting a binary number into a decimal number. More specifically, as shown in FIG. 11, a numerical value represented by a binary number, which designates a value for each digit using “1” as the setting content of “YES” for each setting item and “0” as the setting content of “NO” for each setting item, is converted into a decimal number that represents a setting value.

For example, when the setting content for “prohibit operation of main body operation unit” is “YES”, the setting content for “prohibit switching of inputs” is “NO”, the setting content for “prohibit display of setting menu” is “YES”, the setting content for “prohibit operation of remote controller” is “NO”, and the setting content for “set maximum volume” is “YES”, the pattern for such settings is represented by the binary number of (10101)₂. The binary number of (10101)₂ is converted into the decimal number of 21. Thus, the setting value for this setting pattern is 21. In this manner, in step S26, the display controller 12 (or the control unit 10) performs a calculation for converting the value of the setting pattern represented by a binary number into an index represented by a decimal number. The display controller 12 then displays the computation results as the setting value on the display 7. In this embodiment, when the “maximum volume value” is selected, the value selected as the “maximum volume value” is also shown on the display 7.

Then, the main body operation unit 13 or the operation unit 15a of the remote controller 15 is operated to send a signal for ending the commercial setting to the control unit 10 (step S26). As a result, the display controller 12 stops outputting the OSD signal to the video signal processor 6.

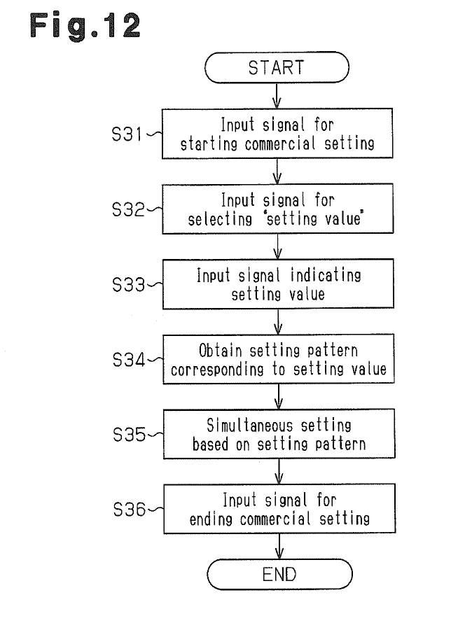

The procedures for simultaneously setting the functions for each of the televisions 1 following the first one by inputting the setting value will now be discussed with reference to FIG. 12.

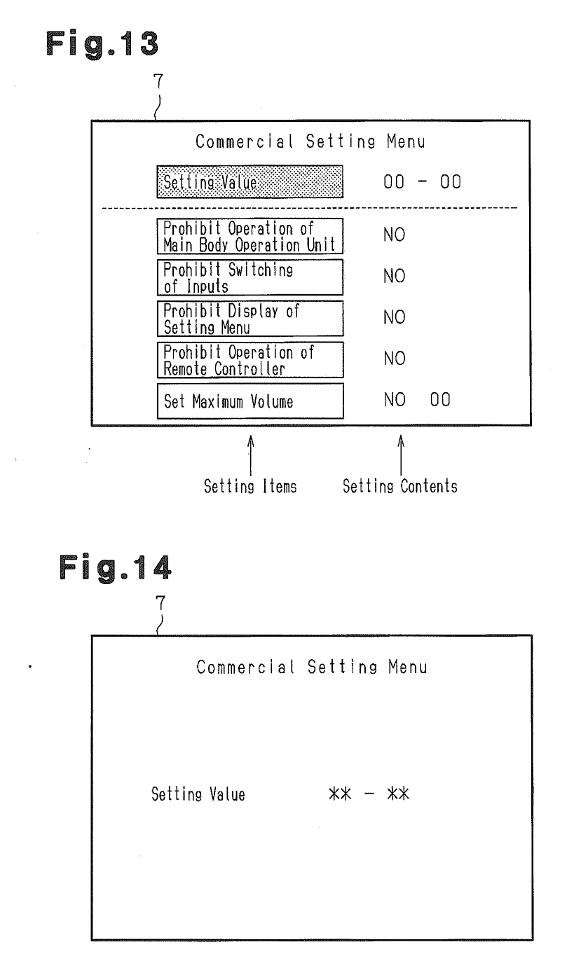

First, in the same manner as in step S21, an employee or the like of a lodging facility who manages the television 1 operates the main body operation unit 13 or the operation unit 15a of the remote controller 15 to input a signal for starting the commercial setting (step S31). When receiving a signal indicating initiation of the commercial setting, the control unit 10 instructs the display controller 12 to show the commercial setting menu, which is an OSD image as shown in FIG. 13, on the display 7.

Then, a signal for selecting the item of the “setting value” is input to the control unit 10 (step S32). That is, an employee or the like of a lodging facility refers to the commercial setting menu shown on the display 7 and operates the cursor movement key 22 and enter key 23 to select the item of “setting value”. When receiving a signal for selecting the item of “setting value”, the control unit 10 sends a control signal to the display controller 12. In response to the control signal, the display controller 12 sends an OSD signal to the video signal processor 6 so as to show a commercial setting menu, which is an OSD image as shown in FIG. 14, on the display 7 to input the setting value.

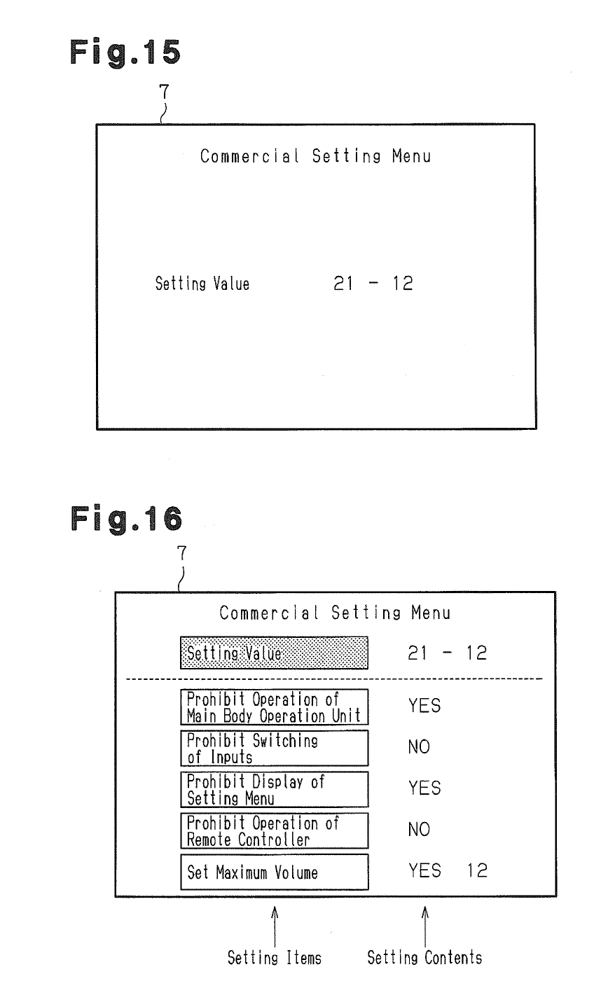

Subsequently, a signal indicating the setting value is input to the control unit 10 (step S33). For example, the numerical keys 18 on the operation unit 15a of the remote controller 15 is operated so that the remote controller 15 transmits a remote control signal indicating the setting value to the remote control signal receiver 14. The signal is input from the remote control signal receiver 14 to the control unit 10. When the control unit 10 receives the signal indicating the setting value, the display controller 12 sends an OSD signal to the video signal processor 6 so that a numeral corresponding to the operated numerical keys 18 is shown on the display 7 as shown in FIG. 15.

Then, the control unit 10 obtains a setting pattern corresponding to the setting value input in step S33 (step S34). More specifically, to satisfy the relationship of the setting value and the setting pattern shown in FIG. 11, the control unit 10 performs a computation for converting the decimal setting value to a binary number to obtain the setting pattern for simultaneous function setting. When receiving a signal indicating 21 as the setting value, the control unit 10 obtains the setting pattern in which the setting content for “prohibit operation of main body operation unit” is “YES”, the setting content for “prohibit switching of inputs” is “NO”, the setting content for “prohibit display of setting menu” is “YES”, the setting content for “prohibit operation of remote controller” is “NO”, and the setting content for “set maximum volume” is “YES”.

The control unit 10 simultaneously sets the functions in accordance with the obtained setting pattern (step S35). More specifically, the control unit 10 writes and stores the setting contents of the setting items to the setting memory 11 in accordance with the obtained setting pattern. Further, the control unit 10 writes and stores the “maximum volume value”, which is input as the setting value in step S33, in the setting memory 11. By inputting the setting value in this manner (i.e., by inputting a signal indicating the setting value), the setting items related to the functions are simultaneously set in any given pattern that corresponds to the setting value.

In step S35, when the setting items related to the functions are simultaneously set in any given pattern that corresponds to the setting value, the display controller 12 sends an OSD signal to the video signal processor 6 to show an OSD image reflecting the setting contents of the setting pattern on the display 7, as shown in FIG. 16.

In the same manner as in step S26, the main body operation unit 13 or the operation unit 15a of the remote controller 15 is operated to send a signal for ending the commercial setting to the control unit 10 (step S36). As a result, the display controller 12 stops outputting the OSD signal to the video signal processor 6.

The television 1 has the advantages described below.

(1) The television 1 includes the display controller 12 and the control unit 10. The display controller 12 shows a setting value, which is an index corresponding to the setting pattern for a plurality of setting items, on the display 7. The control unit 10 simultaneously sets the setting items related to the functions based on a signal indicating the setting value. Thus, when setting a plurality of functions, the television 1 shows on the display 7 a setting value corresponding to any given setting pattern of the setting contents for the setting items that are each set beforehand. This presents the setting value to the user (i.e., an employee or the like of a lodging facility who manages the television 1) who sets the functions. The user causes a signal indicating the setting value to be sent to the control unit 10 so as to simultaneously set the plurality of setting items related to the plurality of functions in the given setting pattern (i.e., setting pattern corresponding to the setting value). In this manner, the user only causes a signal indicating the setting value to be input to the control unit 10 of a television 1 following the first one. As a result, by using the preferred pattern, the user may easily set the same settings for the functions of a plurality of televisions 1.

(2) The television 1 includes a remote control signal receiver 14, which receives a remote control signal indicating a remote control signal. Thus, by performing a remote operation to input a signal indicating the setting value, which is shown on the display 7, to the control unit 10, the user may easily and simultaneously set the plurality of setting items related to the plurality of functions with the setting value corresponding to the given setting pattern.

(3) The display controller 12 shows the computation results of a setting pattern as a setting value on the display 7. Thus, there is no need to store a table associating the setting pattern with the setting value in a memory, such as the setting memory 11.

(4) When a signal indicating the setting value is input to the control unit 10, the display controller 12 determines the setting pattern from the setting value and shows the setting pattern on the display 7. Thus, the user who sets the functions can check whether or not the combination of the setting contents is in accordance with the intended setting pattern for simultaneous function setting.

It should be apparent to those skilled in the art that the present invention may be embodied in many other specific forms without departing from the spirit or scope of the invention. Particularly, it should be understood that the present invention may be embodied in the following forms.

The index corresponding to the setting pattern of the setting items is a setting value represented by a number. However, the index does not have to be represented by a number. For example, an index corresponding to the setting pattern may be a mark or character represented by any one of the buttons on the operation unit 15a of the remote controller 15. Further, the index may be at least any one selected from a group of a numeral, a mark, and a character.

The setting value is obtained by performing a computation on the setting pattern. However, a table may be used to obtain the setting value corresponding to the setting pattern. Such a structure would have the advantages described above except for advantage (3).

A signal indicating the setting value does not have to be input from the remote control signal receiver 14. For example, the main body operation unit 13 may be operated to input a signal indicating the setting value to the control unit 10. In this case, the main body operation unit 13 may be directly operated without using the remote controller 15 so that a signal indicating the setting value shown on the display 7 is input to the control unit 10.

When the main body operation unit 13 is used to input the signal indicating the setting value, the remote control signal receiver 14 is unnecessary for receiving a remote control signal indicating the setting value. Such a structure would have the advantages described above except for advantage (2).

The picture display device is embodied in the television 1 but may be any device that displays a picture based on video information contained in video signals from an external device without receiving broadcast signals. In other words, the picture display device may be any device as long as it includes a display for showing pictures, enables the settings of functions, and enables separate setting of a plurality of setting items when setting the functions.

The present examples and embodiments are to be considered as illustrative and not restrictive, and the invention is not to be limited to the details given herein, but may be modified within the scope and equivalence of the appended claims.

What is claimed is:

1. A picture display device having a plurality of functions individually settable as a plurality of setting items, the picture display device comprising:
a display which shows a picture;
a display controller which shows on the display an index corresponding to a setting pattern of setting contents of the plurality of setting items; and
a function control unit which simultaneously sets the plurality of functions in accordance with the setting contents of the plurality of setting items in the setting pattern in response to input of a signal indicating the index.

2. The picture display device according to claim 1, further comprising:
a remote control signal receiver which receives the signal indicating the index as a remote control signal.

3. The picture display device according to claim 1, further comprising:
an operation unit which is operated to send the signal indicating the index to the function control unit.

4. The picture display device according to claim 1, wherein the function control unit computes the setting pattern, and the display controller shows the computation result as the index on the display.

5. The picture display device according to claim 1, further comprising:
a memory which stores the setting content of each of the plurality of setting items;
wherein the function control unit generates the index corresponding to the setting pattern based on the setting contents of the plurality of setting items stored in the memory.

6. The picture display device according to claim 5, wherein at least one of the plurality of functions is set in accordance with a supplemental setting content in addition to the setting content of the related setting item, and the supplemental setting content is associated with the setting pattern and stored in the memory.

7. The picture display device according to claim 1, wherein the index corresponding to the setting pattern is at least any one selected from a group consisting of a numeral, a mark, and a character.

8. The picture display device according to claim 1, wherein the function control unit uses a plurality of values indicating the setting contents of the plurality of setting items to generate the index corresponding to the setting pattern.

9. The picture display device according to claim 1, wherein the function control unit instructs the display controller to show the setting pattern on the display in response to the input of the signal indicating the index.

10. The picture display device according to claim 9, wherein the function control unit dynamically determines the setting pattern in response to the input of the signal indicating the index and instructs the display controller to simultaneously show on the display the input index and the setting pattern dynamically determined from the input index.
